(19) United States
(12) Patent Application Publication
(10) Pub. No.: US 2001/0052022 A1
(43) Pub. Date: Dec. 13, 2001

(54) Method to transmit an information service in a broadcast transmission system

(76) Inventors: Ralf Schaefer, Fellbach (DE); Rudolf Bittner, Stuttgart (DE)

Correspondence Address: William S. Frommer, Esq, FROMMER LAWRENCE & HAUG LLP, 745 Fifth Avenue, New York, NY, 10151, US

(21) Appl. No.: 09/829,564

(22) Filed: Apr. 10, 2001

(30) Foreign Application Priority Data
Apr. 10, 2000 (EP) 00107695.9

(51) Int. Cl. G06F 15/16

(52) U.S. Cl. 709/236

(57) ABSTRACT

A generic information service structure is assumed and a method to transmit the information service from a server side to an unlimited number of users over a broadcast medium is provided. This transmission method comprises the following steps:—performing a fragmentation within each of categories representing said information service to create data fragments,—adding signalling information to every data fragment, which signalling information allows a consistent reassembly of said data fragments at a receiver on basis of predefined protocol rules, to create respective broadcast objects, and—transmitting said broadcast objects in an order according to an information content of said data fragment within said broadcast object. Preferrably, said fragmentation is performed dependent on the information content of the data to be transmitted.

### DESCRIPTION

The present invention relates to the field of transmission protocols. More particularly, the present invention relates to a broadcast transmission protocol for an information service. i.e. to a method to transmit an information service in a broadcast transmission system.

The DAB Standard, “Radio broadcasting systems; Digital Audio Broadcasting (DAB) to mobile, portable, and fixed receivers”, ETSI, ETS 300 401, Mai 1997, Second Edition is an international standard for implementing a digital broadcast system which supports transmission of a variety of information services from a sender side to an arbitrary number of receiver sides. Examples of said information services are audio stream applications, video stream applications, hypertext applications, picture or text slideshow applications, newsticker applications, Java-based applications and the like.

With the availability of the up-coming DAB system, it is possible to realise an information service, e.g. dedicated to the needs of a car driver. Such an information service has to deal with some specific requirements. In comparison to a PC a display and an input control can be assumed with limited capabilities. Information must be accessible in a fast manner without long-lasting distraction of the driver. Information should be presented in a unified way, so that control of the system becomes intuitively soon.

Therewith, it is an object underlying the present invention to provide a method to transmit an information service in a broadcast transmission system.

This object is solved by a method to transmit an information service in a broadcast transmission system according to claim 1. Preferred embodiments are defined in the dependent claims 2 to 22.

According to the present invention a generic information service structure is assumed and a method to transmit the information service from a server side to an unlimited number of users over a broadcast medium is provided.

This transmission method comprises the following steps:

performing a fragmentation within each of categories representing said information service to create data fragments,

adding signalling information to every data fragment, which signalling information allows a consistent reassembly of said data fragments at a receiver on basis of predefined protocol rules, to create respective broadcast objects, and

transmitting said broadcast objects in an order according to an information content of said data fragment within said broadcast object.

Preferrably, said fragmentation is performed dependent on the information content of the data to be transmitted.

Further preferrably, a broadcast object is classified in dependency on the information content of the data fragment carried within a broadcast object, and a repetition rate of transmitting a broadcast object is dependent on its type.

Still further preferrably, said fragmentation divides a category horizontally in at least two groups by building groups of item attributes of items of said category according to an importance of said item attributes.

Still further preferrably, said fragmentation divides at least parts of a category, in particular at least one group of the horizontally divided category, vertically by building groups of items of said category according to a logical membership of said items.

These general features of the present invention define the transmission of an information not dependent on the occurance or generation of said information, but dependent on its information content. Further, the information is not split only according to system requirements e.g. into transmission frames, but the information is divided also according to its information content.

Therewith, the possibility for a quick and satisfying reassembly of the information service at the receiver side is provided, in particular it is secured that a receiver receives and is able to reassemble the information according to its importance, i.e. acording to its information content. An advantage of this scheme is that the importance of an information can be determined at the transmitter side which knows the whole information service and the most important information can be transmitted more often to secure that the provided information service comprises an up to date content.

Further, it is an object underlying the present invention to provide a method to receive an information service in a broadcast transmission system and a receiver therefore.

This object is solved by a method to receive an information service in a broadcast transmission system according to claim 23. Preferred embodiments are defined in the dependent claim 24 which refers back to claims 2 to 22. A receiver according to the present invention is defined in claim 24.

This reception method comprises the following steps:

receiving broadcast objects;

extracting signalling information and a data fragment of every received broadcast object, which signalling information allows a consistent reassembly of said data fragments into an information category of said information service on basis of predefined protocol rules; and

performing a defragmentation within each of categories representing said information service to create said information service.

Therefore, the present invention provides a transmission protocol for an information service based on a digital broadcast medium which is the first choice when information is to be provided to a large number of users. Information for all potential users is broadcast in a broadcast channel and a client filters currently relevant information. The access time for a certain piece of information depends largely on the organisation of data in the broadcast channel which is advantageously defined according to the present invention.

The broadcast transmission protocol according to the present invention provides means for a reliable transmission and for adequate access times. Reliable transmission includes prevention of data distortion and guaranteeing data consistency. Adequate access times are achieved by building chunks of information in a way which fits to the nature of a broadcast medium.

Organisation of data in an information system when used in a terminal is not suited for a broadcast transmission, because of its stationary use. Instead data to be broadcast gets amended by signalling information to guarantee reliable transmission and organisation of data gets rearranged in order to achieve adequate access times.

The present invention assumes a generic structure for an information service and provides a method to transmit all information with a broadcast medium to a large number of users, thereby providing means for reliable transmission and adequate access times at start-up time and in case of information updates.

The accompanying drawings, which are incorporated in and constitute a part of this specification, illustrate embodiments of the invention and, together with a general description of the invention given above, and the detailed description of the embodiment given below, serve to explain the principles of the invention, wherein:

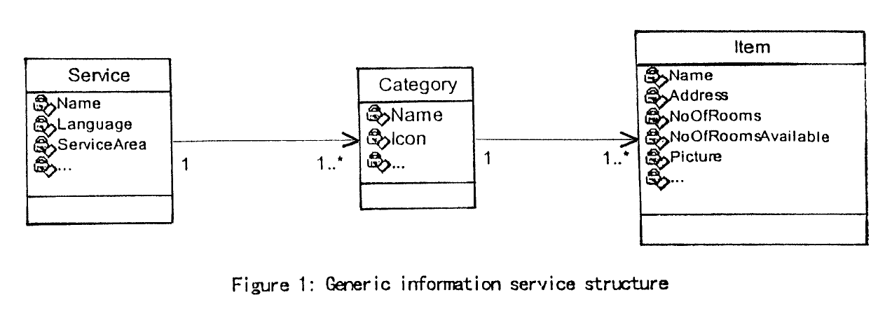

FIG. 1 shows the generic information service structure according to an embodiment of the present invention;

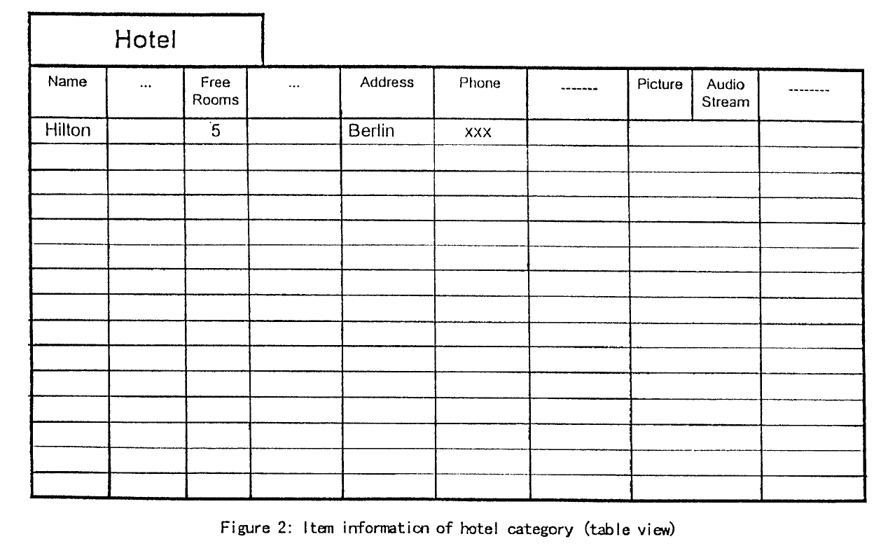

FIG. 2 depicts item information of an information category according to the embodiment shown in FIG. 1;

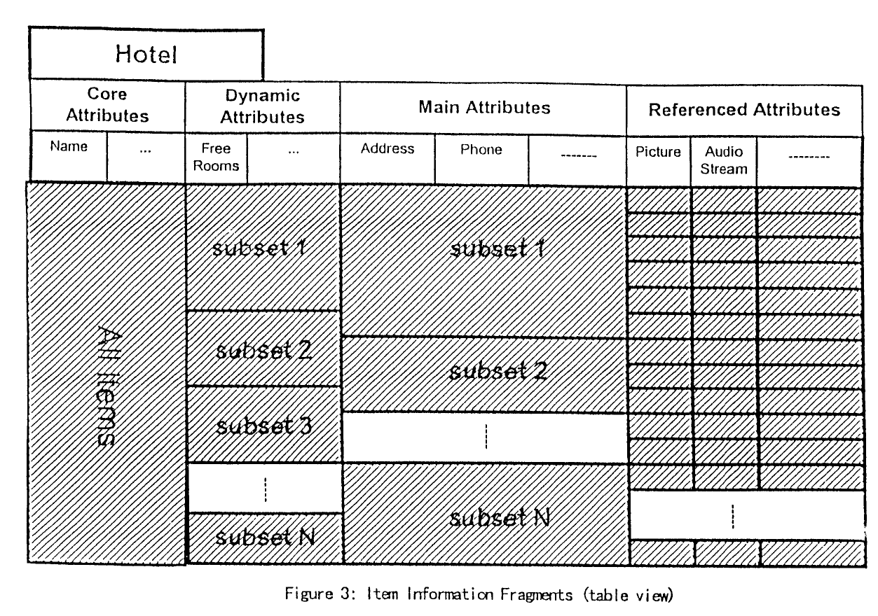

FIG. 3 illustrates item information fragments within the information category shown in FIG. 2;

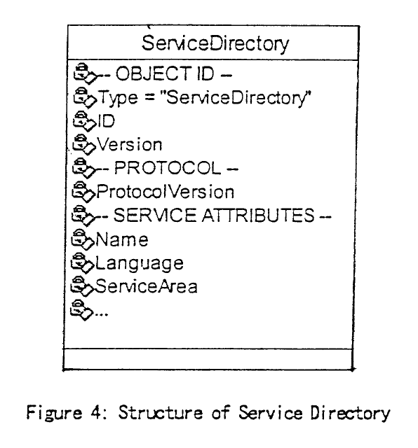

FIG. 4 shows the structure of a service directory according to the embodiment shown in FIG. 1;

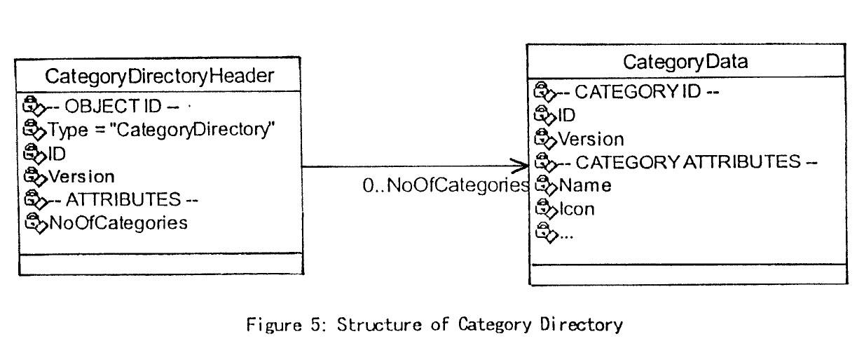

FIG. 5 shows the structure of a category directory according to the embodiment shown in FIG. 1;

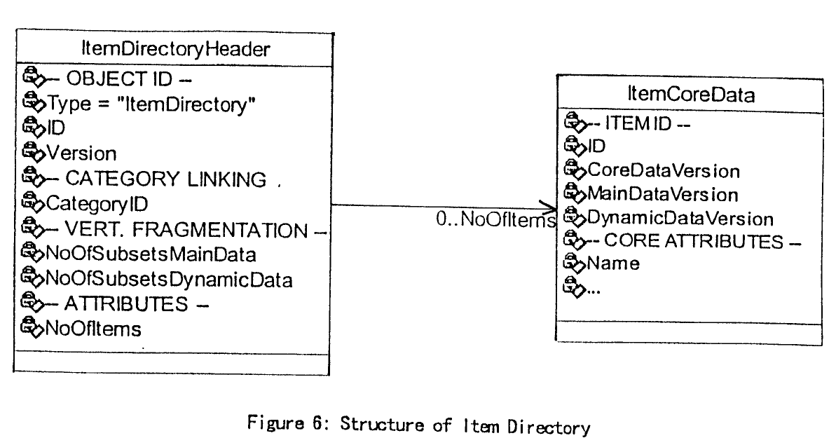

FIG. 6 shows the structure of an item directory according to the embodiment shown in FIG. 1;

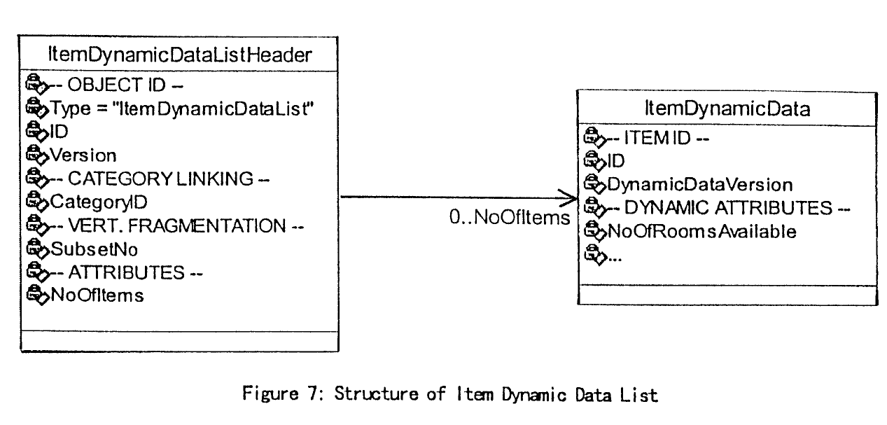

FIG. 7 shows the structure of an item dynamic data list according to the embodiment shown in FIG. 1:

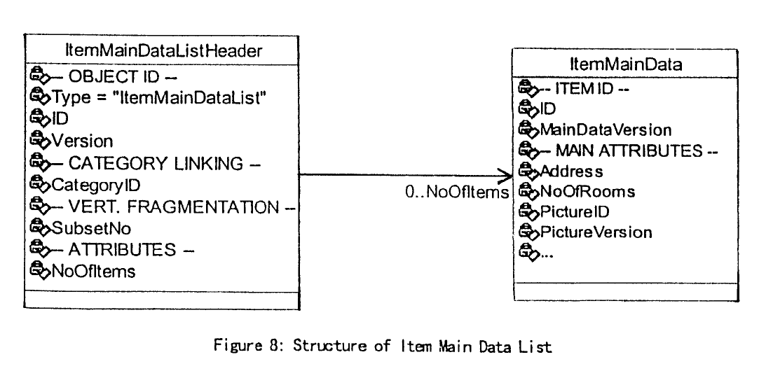

FIG. 8 shows the structure of an item main data list according to the embodiment shown in FIG. 1;

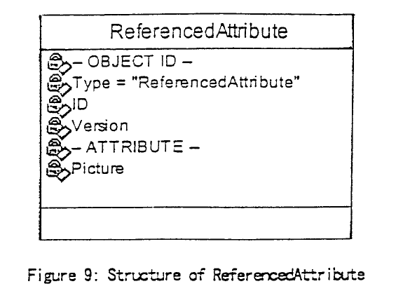

FIG. 9 shows the structure of referenced attributes according to the embodiment shown in FIG. 1;

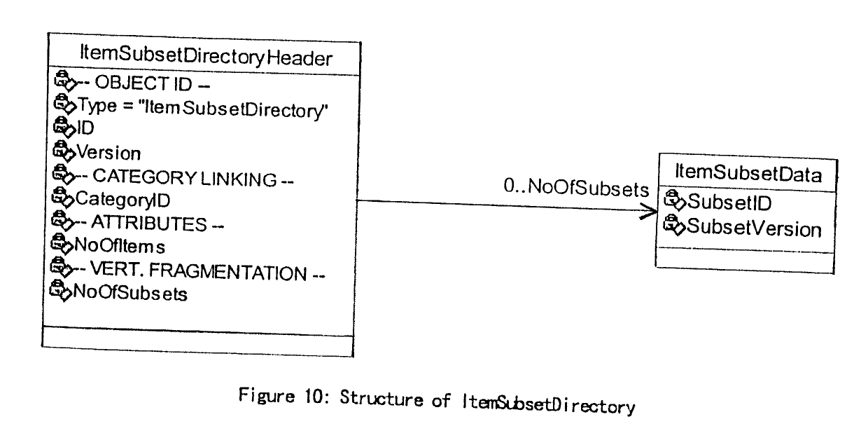

FIG. 10 shows the structure of an item subset directory according to the embodiment shown in FIG. 1; and

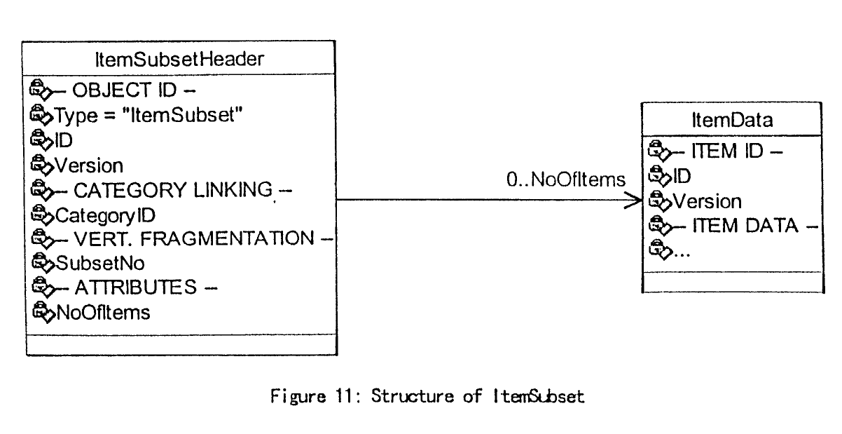

FIG. 11 shows the structure of an item subset according to the embodiment shown in FIG. 1.

In the following a preferred embodiment of the invention is described by use of the accompanying figures. However, the invention is not limited to this specific embodiment which is an advantageous realization and shows in particular the rules for the transmission protocol, i.e. fragmentation to generate broadcast objects to be transmitted. Of course, the reception, i.e. defragmentation, needs to be performed according to rules corresponding to the rules for fragmentation to correctly rebuild the transmitted information service.

A table-oriented view is used to explain the basic idea of data fragmentation (FIGS. 2 and 3). All other illustrations show either the structure of service objects (FIG. 1) or broadcast objects (FIGS. 4-9) by use of UML models (UML=Unified Modelling Language). UML is a standard for the design of object-oriented systems. Every object defines an entity, which consists of a set of attributes. For better readability some comments are inserted. The comments are surrounded by “—” signs. FIGS. 4 to 9 show each the structure of one broadcast object although illustrated by two associated entities.

FIG. 1 depicts the generic structure of an information service to be broadcast using the method of the present invention. It consists basically of three types of service objects, which are Service, Category and Item. Every service object may have several attributes with several types and cardinalities. The relationship between Service, Category and Item is that the information service (Service) consists of one to many information categories (Category) and an information category has one to many items.

The Service object is the entry point for the service. It provides any information considered useful for the user when choosing a certain service among several others. Example attributes are a label (Name) indicating what information is provided by a service, a language (Language) information or which geographical area (ServiceArea) is covered in case of a mobile information service. It depends on the information service which attributes should be provided here.

An information category (Category) is a container for one to many items. Besides linking all items of one category together it may provide some additional attributes like a label which indicates the content of the information category (Name) or an icon (Icon) to be used for the selection of an information category by the user. Again. it depends on the information service which attributes should be provided here. Examples for categories are hotel information or sights.

An item (Item) carries most of the information the user is interested in. An example for an item is a hotel from an information category hotel information. All items belonging to one information category share the same set of attributes, although it is possible that some parts are mandatory while others are optional. Examples for item attributes are a hotel name (Name), an address (Address), the total number of rooms (NoOfRooms), the currently available number of rooms (NoOfRoomsAvailable) or a picture of the item (Picture). Again, it depends on the information service which attributes should be provided here. The set of item attributes is defined on a per category basis.

FIG. 2 shows the complete set of user relevant item information belonging to one category in a table. The example shows the hotel category. Every row contains the data related to one hotel instance. Every column contains attribute values for all hotels.

Definition of Broadcast Objects: Fragmentation

As the first step for broadcast transmission data fragments are defined. These data fragments are the basis for the creation of broadcast objects. Therefore a horizontal and vertical fragmentation scheme is applied as depicted in FIG. 3.

The horizontal fragmentation results in four groups of attributes. The Core Attributes group covers a very small set of the most important attributes, which should be available in a terminal first on average. The Dynamic Attributes group covers all attributes, which are likely to change much more frequent than all the others. The Main Attributes group covers all remaining attributes and provides detailed information about an item. The fourth group of attributes is a special one. It consists of attributes belonging to one of the other three groups, which are to be transmitted separately, e.g. large pictures, audio streams or video streams. A large picture e.g. could be an important feature for an information service, but due to the large bandwidth required it could be necessary to broadcast it with a very low repetition rate. Therefore the present invention provides a mechanism to broadcast such attributes in a separate manner. In the following this group of attributes is called the Referenced Attributes Group. Referenced Attributes are still part of the respective group (Core, Main, Dynamic) as references, but the data itself is transmitted as an additional broadcast object.

The vertical fragmentation results in item subsets of the complete set of category items. How many vertical fragments shall be used and which items are to be assigned to a fragment depends on the application domain. An example is to divide the item set according to the geographical area. This might result in two subsets, one for local information and one for global information.

The vertical fragmentation scheme is applied on the Dynamic Attributes group and the Main Attributes group. The Core Attributes group consists always of the complete set of all items. This leads to the following types of broadcast objects on a per category basis:

Item Directory: The Item Directory contains the core attributes of all items.

Item Dynamic Data List [1 . . . N]: The Item Dynamic Data List[x] contains the dynamic attributes of all items belonging to subset x.

Item Main Data List [1 . . . N]: The Item Main Data List[x] contains the main attributes of all items belonging to subset x.

Referenced Attributes

Additional types of broadcast objects are:

Category Directory: The Category Directory contains a complete list of all categories with all category attributes. It provides an overview about available categories. It exists only one object per service.

Service Directory: The Service Directory object provides elementary information to get access to the information service. It may contain information useful for the user to decide if he wants to start the service or not. The Service Description object is the entry point to the service. It exists only one object per service.

The mechanism of Referenced Attributes can also easily be applied on the Category Directory and Service Directory.

Definition of Broadcast Objects: Signalling Information

As the second step for broadcast transmission identified data fragments are amended by signalling information attributes in order to guarantee consistency when reassembling the fragments in the terminal after reception.

First of all every broadcast object has an Object ID. The Object ID consists of the Type attribute, the ID attribute and the Version attribute. The Type attribute identifies the type of the broadcast object, e.g. Service Directory, Category Directory and so on. The ID attribute identifies uniquely a broadcast object of a certain type among other broadcast objects of a certain type. The Version attribute is used to indicate that a broadcast object is updated.

FIG. 4 depicts the structure of the Service Directory object. Besides the information service specific attributes Name, Language, ServiceArea and so on from the Service object, it provides the following signalling information:

Object ID: The Object ID consists of the above mentioned attributes Type, ID and Version. The Type attribute identifies the broadcast object as a Service Directory.

Protocol: The ProtocolVersion attribute is used by the receiving terminal to check protocol compatibility between the broadcast service and the processing unit in the terminal.

FIG. 5 depicts the structure of the Category Directory object. It consists of the Object ID, the NoOfCategories attribute and the Category Data.

Object ID: The Object ID consists of the above mentioned attributes Type, ID and Version. The Type attribute identifies the broadcast object as a Category Directory.

NoOfCategories: The NoOfCategories attribute indicates the number of categories the service consists of and how many Category Data attribute sets are delivered with the Category Directory.

Category Data: Every category is described by the attributes of Category Data. Besides information service specific attributes Name, Icon and so on from the Category object, it provides a Category ID. The Category ID consists of an ID attribute, which uniquely identifies a category among other categories, and a Version attribute, which is used to indicate that a category is updated. Additionally the Category ID is used to link items together with their respective category.

FIG. 6 depicts the structure of the Item Directory object. It consists of the Object ID, the category linking information, the vertical fragmentation information, the NoOfItems attribute and the Item Core Data.

Object ID: The Object ID consists of the above mentioned attributes Type. ID and Version. The Type attribute identifies the broadcast object as an Item Directory.

Category ID: The category linking information specifies the category to which the provided items belong.

Vertical Fragmentation: Two attributes are provided which specify the number of subsets used to transmit the complete set of items of the respective category. The NoOfSubsetsMainData attribute indicates the number of subsets used for the Main Attributes group. This means that as many ItemMainDataList broadcast objects are transmitted as indicated by NoOfSubsetsMainData. The NoOfSubsetsDynamicData attribute indicates the number of subsets used for the Dynamic Attributes group. This means that as many ItemDynamicDataList broadcast objects are transmitted as indicated by NoOfSubsetsDynamicData.

NoOfItems: The NoOfItems attribute indicates the number of items the respective category consists of and how many attribute sets Item Core Data are delivered with the Item Directory.

Item Core Data: Every item is described by the attributes of Item Core Data. Besides information service specific attributes like Name and so on from the Item object, it provides an Item ID. The Item ID consists of an ID attribute, which uniquely identifies an item among other items of the respective category, and three Version attributes, which are used to indicate that an item is updated. The CoreDataVersion attribute indicates changes of attributes in the Core Attribute group. All core attributes are delivered with the Item Directory. Additionally, the MainDataVersion and the DynamicDataVersion attributes are delivered. The MainDataVersion attribute indicates changes of attributes in the Main Attribute group. The DynamicDataVersion attribute indicates changes of attributes in the Dynamic Attribute group. All main attributes are delivered with ItemMainDataList objects and all dynamic attributes are delivered with ItemDynamicDataList objects.

FIG. 7 depicts the structure of the Item Dynamic Data List object. It consists of the Object ID. the category linking information, the vertical fragmentation information, the attribute NoOfItems and the Item Dynamic Data.

Object ID: The Object ID consists of the above mentioned attributes Type, ID and Version. The Type attribute identifies the broadcast object as an Item Dynamic Data List.

Category ID: The category linking information specifies the category to which the provided items belong.

Vertical Fragmentation: The SubsetNo attribute indicates the number of the subset of items provided with current Item Dynamic Data List object. The Item Directory object of the respective category contains the NoOfSubsetsDynamicData attribute, which indicates the total number of subsets.

NoOfItems: The attribute NoOfItems indicates the number of items the current subset of the respective category consists of and how many attribute sets Item Dynamic Data are delivered with current Item Dynamic Data List object.

Item Dynamic Data: Every item is described by the attributes of Item Dynamic Data. Besides information service specific attributes like NoOfRoomsAvailable and so on from the Item object, it provides an Item ID. The Item ID consists of an ID attribute, which uniquely identifies an item among other items of the respective category, and a Version attribute. The DynamicDataVersion attribute indicates that attributes in the Dynamic Attributes group of an item are updated.

FIG. 8 depicts the structure of the Item Main Data List object. It consists of the Object ID, the category linking information, the vertical fragmentation information, the NoOfItems attribute and the Item Main Data.

Object ID: The Object ID consists of the above mentioned attributes Type, ID and Version. The Type attribute identifies the broadcast object as an Item Main Data List.

Category ID: The category linking information specifies the category to which the provided items belong.

Vertical Fragmentation: The SubsetNo attribute indicates the number of the subset of items provided with current Item Main Data List object. The Item Directory object of the respective category contains the NoOfSubsetsMainData attribute, which indicates the total number of subsets.

NoOfItems: The attribute NoOfItems indicates the number of items the current subset of the respective category consists of and how many attribute sets Item Main Data are delivered with current Item Main Data List object.

Item Main Data: Every item is described by the attributes of Item Main Data. Besides information service specific attributes like Address, NoOfRooms, and so on from the Item object, it provides an Item ID and Referenced Attribute Picture. The Item ID consists of an ID attribute, which uniquely identifies an item among other items of the respective category, and a Version attribute. The MainDataVersion attribute indicates that attributes in the Main Attributes group of an item are updated. The Referenced Attribute Picture is supported by a reference to another broadcast object. The reference consists of two attributes PicturelD and PictureVersion. The PictureID corresponds to the ID attribute of the broadcast object (ReferencedAttribute) carrying the attribute value (picture data). The PictureVersion attribute identifies the latest version of the picture and corresponds to the Version attribute of the broadcast object.

FIG. 9 depicts the structure of the Referenced Attribute object. It consists of the Object ID and the referenced attribute.

Object ID: The Object ID consists of the above mentioned attributes Type. ID and Version. The Type attribute identifies the broadcast object as an Referenced Attribute.

Referenced Attribute: This is the referenced attribute itself. e.g. the picture data in case of a referenced picture.

Additional Protocol Rules

As the third step for broadcast transmission additional protocol rules are defined. The protocol rules in combination with signalling information allow consistent re-assembly of broadcast data.

Broadcast Object Identification

Objects transmitted in a broadcast channel can not be identified by the communication state between sender and receiver as often done in bi-directional communication environments. Instead every object must identify itself. Therefore three attributes are provided. Every broadcast object has a Type attribute, an ID attribute and a Version attribute. The Type attribute indicates the type of the broadcast object, which is used to apply the proper decoding scheme in the receiving terminal. The ID attribute is used to distinguish several broadcast objects, which have the same type. The Version attribute indicates changes of a certain broadcast object. Thereby the receiving terminal can determine if the information in the broadcast object is already known without decoding the whole object.

Category Linking

A Category provides attributes describing the category itself and is a container for items of the respective category. In order to link a category together with its items the broadcast objects carrying item information have a CategoryID attribute. The CategoryID attribute specifies uniquely an information category. All categories belonging to the service are transmitted with their attributes in the CategoryDirectory. Thereby it is guaranteed that items can be linked together with their respective categories.

Referenced Attribute Versioning

Attributes of all three attributes group (Core, Main, Dynamic) can be transmitted as separate broadcast objects (Referenced Attributes). In this case the original location of the attribute uses a reference to the attribute. The reference corrsists of an ID and a version attribute. The ID corresponds to the ID of the broadcast object carrying the attribute. The version attribute corresponds to the Version attribute of the broadcast object. In order to bring attribute reference and the attribute itself together in the terminal, these two attributes must be matched. This means ID and Version must have the same values.

If a referenced attribute is to be updated, the Version attribute of the Referenced Attribute object indicates an update (e.g. increment counter). In this case also the version of the attribute reference indicates an update. Additionally it is possible that not the referenced attribute changes its value, e.g. improved picture, but that the reference changes. This means the referenced attribute is another ReferencedAttribute object. In this case the ID is exchanged and the version information of the newly referenced attribute is used.

Item Versioning and horizontal fragmentation

All item attributes of a certain category are grouped in three groups (horizontal fragmentation): the Core Attributes group, the Main Attributes group and the Dynamic Attributes group. In order to indicate information updates each group has its own version attribute. The CoreDataVersion attribute is used for the Core Attributes group, the MainDataVersion attribute is used for the Main Attributes version and the DvnamicDataVersion attribute is used for the Dynamic Attributes group.

All three attributes are sent together with the ItemDirectory, thereby providing a complete information about the latest version of an item. The MainDataVersion attribute is sent additionally with the ItemMainDataList object and indicates any changes in the Main Attributes group of an item. The DynamicDataVersion attribute is sent additionally with the ItemDynamicDataList object and indicates any changes in the Dynamic Attributes group of an item.

The protocol rule for item versioning is as follows:

Indicate an information update by use of the CoreDataVersion attribute (e.g. increment counter), whenever an item attribute value or an item attribute cardinality of the Core Attributes group changes. This includes the case when with attribute referencing the reference is changed (Attribute ID) or the version of the referenced attribute is changed (Attribute Version).

Indicate an information update by use of the MainDataVersion attribute (e.g. increment counter), whenever an item attribute value or an item attribute cardinality of the Main Attributes group changes. This includes the case when with attribute referencing the reference is changed (Attribute ID) or the version of the referenced attribute is changed (Attribute Version).

Indicate an information update by use of the DynamicDataVersion attribute (e.g. increment counter), whenever an item attribute value or an item attribute cardinalitv of the Dynamic Attributes group changes. This includes the case when with attribute referencing the reference is changed (Attribute ID) or the version of the referenced attribute is changed (Attribute Version).

Vertical Fragmentation of Items

The complete set of items belonging to a certain category can be divided in several subsets and transmitted as several broadcast objects. This can be used e.g. to decrease the impact of transmission errors or to provide different access times for different item subsets. The Item Directory indicates the number of subsets used for the Main Attributes group and the Dynamic Attributes group respectively by use of NoOfSubsetsMainData and NoOfSubsetDynamicData attributes. The item subsets are carried with the ItemMainDataList and the ItemDynamicDataList objects. These objects indicate by use of the SubsetNo attribute the number of the item subset provided by the current broadcast object. Additionally the NoOfItems attribute specifies how many items belong to the subset.

Item Directory Versioning

The Item Directory carries always a complete list of all items with their core attributes belonging to the respective category. The Version attribute of an Item Directory indicates an update (e.g. increment counter), when:

the Item set changes:

Number of items changes: NoOfItems attribute changes.

Items are added: New items (ID attribute) are added to the Item Directory.

Items are removed: Items (ID attribute) are removed from the Item Directory.

Items are updated: Item version information (CoreDataVersion, MainDataVersion, DynamicDataVersion attributes) changes.

or the vertical fragmentation changes: NoOfSubsetsMainData or NoOfSubsetsDynamicData attributes changes.

Item Main Data List Versioning

The Item Main Data List carries a subset of all items with their main attributes belonging to the respective category. The Version attribute of an Item Main Data List object indicates an update (e.g. increment counter), when:

the Item subset changes:

Number of items belonging to the subset changes: NoOfItems attribute changes.

Items are added: New items (ID attribute) are added to the item subset.

Items are removed: Items (ID attribute) are removed from the item subset.

Items are updated: Item version information related to the Main Attributes group (MainDataVersion attributes) changes.

or the vertical fragmentation changes: SubsetNo attribute changes.

Item Dynamic Data List Versioning

The Item Dynamic Data List carries a subset of all items with their dynamic attributes belonging to the respective category. The Version attribute of an Item Dynamic Data List object indicates an update (e.g. increment counter), when:

the Item subset changes:

Number of items belonging to the subset changes: NoOfItems attribute changes.

Items are added: New items (ID attribute) are added to the item subset.

Items are removed: Items (ID attribute) are removed from the item subset.

Items are updated: Item version information related to the Dynamic Attributes group (DynamicDataVersion attributes) changes.

or the vertical fragmentation changes: SubsetNo attribute changes.

Category Versioning

All categories belonging to the service are transmitted with the Category Directory. A Category is identified by the ID attribute (Category Data). Updates to a category are indicated by the Version attribute. The Version attribute indicates an update (e.g. increment counter), when a category attribute value or a category attribute cardinality changes. This includes changes resulting from attribute referencing.

Category Directory Versioning

The Category Directory carries always a complete list of all categories belonging to the service. The Version attribute of the Category Directory indicates an update (e.g. increment counter), when the Category set changes:

Number of categories changes: NoOfCategories attribute changes.

Categories are added: New categories (ID attribute) are added to the Category Directory.

Categories are removed: Categories (ID attribute) are removed from the Category Directory.

Categories are updated: Category version information (Version attribute of Category Data) changes.

Service Directory Versioning

The Service Directory carries information relevant to the service as such. This includes some attributes for a human user as well as a protocol information. The ProtocolVersion attribute indicates changes to the transmission protocol. e.g. data format changes or protocol rule changes.

The Version Attribute of the Service Directory changes, when the ProtocolVersion attribute changes or at least one of the service attributes changes. This includes changes resulting from attribute referencing.

Extension: Embedding Information Categories in a Predefined Format

When realizing an information service it is likely that information from different information sources is obtained. While in most cases it might be appropriate to convert the original information structure of respective information source, this cannot be assumed for all situations. The GATS protocol e.g. is used for delivery of traffic incident messages to mobile phones. It uses an efficient, binary message format. Each message consists of a mandatory and optional parts and requires about 20 byte per traffic message on average. Applying a horizontal fragmentation scheme might not be useful in this situation, because of the low bandwidth requirement of a complete traffic message. Additionally, it might be unlikely that a content provider for traffic messages in the GATS protocol format supports an information delivery according to described horizontal fragmentation scheme. Therefore, the following part of the invention deals with the embedding of an information category in a format, that should be preserved. The basic assumption is that each item can be handled piece by piece as a whole. The internal structure of an item, e.g. its attributes or attribute cardinalities is not relevant for the broadcast transmission protocol described in the present invention. This leads to a solution in which only a vertical fragmentation scheme is applied, but not a horizontal scheme. Additionally, the item data in a predefined format is transmitted with an additional broadcast object, in order to enable different formats. To summarize this, two broadcast objects ItemSubsetDirectory and ItemSubset are used to embed the information category.

FIG. 10 depicts the structure of the Item Subset Directory object. It is the equivalent of the Item Directory object. It consists of the Object ID, the category linking information, the NoOfItems attribute, the vertical fragmentation information, and the Item Subset Data.

Object ID: The Object ID consists of the above mentioned attributes Type, ID and Version. The Type attribute identifies the broadcast object as an Item Subset Directory.

Category ID: The category linking information specifies the category to which the provided items belong.

NoOfItems: The NoOfItems attribute indicates the total number of items the respective category consists of.

Vertical Fragmentation: The NoOfSubsets attribute indicates the number of subsets used for delivery of the complete set of items and how many attribute sets Item Subset Data are delivered with current Item Subset Directory object. Additionally, this means that as many ItemSubset broadcast objects are transmitted as indicated by NoOfSubsets.

Item Subset Data: Every subset is described by the attributes of Item Subset Data. It provides two attributes SubsetID and SubsetVersion. The SubsetID corresponds to the ID attribute of the broadcast object (Item Subset) carrying the subset data. The SubsetVersion attribute identifies the latest version of the subset data and corresponds to the Version attribute of the broadcast object.

FIG. 11 depicts the structure of the ItemSubset object. It consists of the Object ID, the category linking information, the vertical fragmentation information, the NoOfItems attribute and the Item Data:

Object ID: The Object ID consists of the above mentioned attributes Type, ID and Version. The Type attribute identifies the broadcast object as an Item Subset.

Category ID: The category linking information specifies the category to which the provided items belong.

Vertical Fragmentation: The SubsetNo attribute indicates the number of the subset of items provided with current Item Subset object The Item Subset Directory object of the respective category contains the NoOfSubsets attribute, which indicates the total number of subsets.

NoOfItems: The attribute NoOfItems indicates the number of items the current subset of the respective category consists of and how many items are delivered with current Item Subset object.

Item Data: Every item is provided in a predefined format, which might differ from the format used for the broadcast transmission protocol described in the present invention and which is not relevant for the protocol. The protocol provides only a container, which carries this kind of data. It is assumed that every item has an ID attribute, which uniquely identifies an item among other items of the same category and a Version attribute that indicates changes to an item. Additional information provided for an item is not relevant for the present invention.

Additional Protocol Rules for Embedding of Information Category in Predefined Format

The embedding of an information category in a predefined format follows basically the principles as described for the protocol without this extension, but some slight modifications are necessary.

Broadcast Object Identification

Same as before.

Category Linking

Same as before.

Item Versioning

No horizontal fragmentation is supported. Therefore only one version attribute for each item is required. All version attributes are sent with their respective items in a ItemSubset object.

The protocol rule for item versioning is as follows: Indicate an information update by use of the Version attribute (e.g. increment counter), whenever an item changes in accordance to the rules of the embedded information category.

Vertical Fragmentation of Items

The complete set of items belonging to a certain category can be divided in several subsets and transmitted as several broadcast objects. This can be used e.g. to decrease the impact of transmission errors or to provide different access times for different item subsets. The Item Subset Directory indicates the number of subsets used for the item set by use of the NoOfSubsets attribute. The item subsets are carried with ItemSubset objects. This object indicates by use of the SubsetNo attribute the number of the item subset provided by the current broadcast object. Additionally the NoOfItems attribute specifies how many items belong to the subset.

Item Subset Directory Versioning

The Item Subset Directory carries always a complete list of all subsets carrying items belonging to the respective category. The Version attribute of an Item Subset Directory indicates an update (e.g. increment counter), when:

the Item subset organization changes:

Number of subsets changes: NoOfSubsets attribute changes.

Subsets are added: New subsets (SubsetID attribute) are added to the Item Subset Directory.

Subsets are removed: Subsets (SubsetID attribute) are removed from the Item Subset Directory.

Subsets are updated: Subset version information (SubsetVersion attribute) changes.

or the number of items belonging to the category changes: NoOfItems attribute changes.

Item Subset Versioning

The Item Subset carries a subset of all items belonging to the respective category. The Version attribute of an Item Subset object indicates an update (e.g. increment counter), when:

the Item subset changes:

Number of items belonging to the subset changes: NoOfItems attribute changes.

Items are added: New items (ID attribute) are added to the item subset.

Items are removed: Items (ID attribute) are removed from the item subset.

Items are updated: Item version information (Version attribute) changes.

or the vertical fragmentation changes: SubsetNo attribute changes.

Category Versioning

Same as before.

Category Directory Versioning

Same as before.

Service Directory Versioning

Same as before.

Although the present invention has been described by way of an information service to be broadcast consisting of three types of service objects, an information service to be broadcast according to the present invention may comprise more or less types of service objects.

Further, it is described that the horizontal fragmentation results in four groups of attributes. Of course, the horizontal fragmentation might result in more or less groups of attributes. It is also possible that different information categories comprise a different number of groups of attributes or that the general horizontal fragmentation defines a certain number of attribute groups and one or more groups of attributes are not present in one or more information categories.

Also, the vertical fragmentation is not restricted to the shown example, but can be adapted according to the needs of the realized transmission system.

In case of more or less types of service objects, another number of groups of attributes and/or another number of item sets (vertical fragmentation), of course, the number and types of attribute objects will vary accordingly.

Furthermore, also the additional protocol rules which are shown and described for the specific exemplary embodiment can be adapted accordingly.

1. Method to transmit an information service in a broadcast transmission system, characterized by the following steps:
performing a fragmentation within each of categories representing said information service to create data fragments,
adding signalling information to every data fragment, which signalling information allows a consistent reassembly of said data fragments at a receiver on basis of predefined protocol rules, to create respective broadcast objects, and
transmitting said broadcast objects in an order according to an information content of said data fragment within said broadcast object.

2. Method according to claim 1, characterized in that said fragmentation is performed dependent on the information content of the data to be transmitted.

3. Method according to claim 1, characterized in that a broadcast object is classified in dependency on the information content of the data fragment carried within a broadcast object, and a repetition rate of transmitting a broadcast object is dependent on its type.

4. Method according to claim 1, characterized in that said information service comprises a structure with three layers, namely
service which provides information considered useful for a user when choosing a service among several others;
category which links several items: and
item which carries the information the user is interested in.

5. Method according to claim 1, characterized in that said fragmentation divides a category horizontally in at least two groups by building groups of item attributes of items of said category according to an importance of said item attributes.

6. Method according to claim 5, characterized in that four groups of item attributes are build, namely:
a core attributes group which covers a set of the most important attributes, which should be available in a terminal first on average;
a dynamic attributes group which are likely to change with a higher frequency that other attributes;
a main attributes group which covers all remaining item attributes: and
a referenced attributes group which consists of attributes belonging to one of the other three attribute groups which are included therein as reference only and to be transmitted seperately, e.g. because they comprise a high amount of data.

7. Method according to claim 1, characterized in that said fragmentation divides at least parts of a category vertically by building groups of items of said category according to a logical membership of said items.

8. Method according to claim 7, characterized in that two types of broad cast objects are defined, namely:
item subset directory containing information about all items which are transmitted in a predefined format; and
item subset containing item data of a predefined format.

9. Method according to claim 6, characterized in that six types of broadcast objects are defined, namely:
service directory containing elementary information about a service;
category directory containing a compete list of all categories within a service;
item directory containing all core attributes of all items of a category;
item dynamic data list containing the dynamic attributes of at least a group of items;
item main data list containing the main attributes of at least a group of items; and
referenced attributes containing one referenced attribute of one item.

10. Method according to claim 9, characterized in that the signalling information of a service directory broadcast object comprises a protocol version attribute to enable a receiving terminal to check protocol compatibility between the broadcast service and a processing unit in the terminal.

11. Method according to claim 1, characterized in that the signalling information of a broadcast object comprises a type attribute indicating a classification of said broadcast object, and/or an ID attribute to distinguish several broadcast objects of a same type of broadcast objects, and/or a version attribute to indicate a change of a certain broadcast object.

12. Method according to claim 11, characterized in that a reference to a referenced attribute comprises the ID of the broadcast object carrying the referenced attribute and a version attribute of the referenced broadcast object.

13. Method according to claim 12, characterized in that in case of an update of a referenced attribute the version attribute of the referenced attribute object and the version of the attribute reference change, or the reference changes by exchanging the identifier and using the version information of the newly referenced attribute.

14. Method according to claim 6, characterized in that the item core attributes group, the item main attributes group and the item dynamic attributes group each comprise an own version attribute which indicates an information update whenever an item attribute value or an item attribute cardinality of the respective item attributes group changes.

15. Method according to claim 14, characterized in that a broadcast object comprising an item of the item core attributes group and of the item directory carries all three version attributes, a broadcast object comprising an item of the item main attributes group carries a main version attribute, and a broadcast object comprising an item of the item dynamic attributes group carries a dynamic version attribute.

16. Method according to claim 9, characterized in that the item directory comprises a version attribute which indicates an update whenever an item set comprising all core attributes of all items of a category changes or the vertical fragmentation changes.

17. Method according to claim 9, characterized in that the item main data list and the item dynamic data list respectively comprise a version attribute which indicates an update whenever a respective item subset comprising the respective main or dynamic attributes of at least a group of items changes or the vertical fragmentation changes.

18. Method according to claim 9, characterized in that the category directory comprises a version attribute which indicates an update whenever a category directory attribute value or a category attribute cardinality changes.

19. Method according to claim 9, characterized in that the category directory comprises a version attribute which indicates an update whenever a category set comprising a compete list of all categories within a service changes.

20. Method according to claim 9, characterized in that the service directory comprises a version attribute which indicates an update whenever the protocol version attribute or a service attribute changes.

21. Method according to claim 1, characterized in that the signalling information of a broadcast object carrying a fragment of a category comprises a category ID attribute which specifies uniquely an information category and attributes which allow the defragmentation of the category.

22. Method according to claim 1, characterized in that said broadcast transmission system is DAB.

23. Method to receive an information service in a broadcast transmission system, characterized by the following steps:
receiving broadcast objects;
extracting signalling information and a data fragment of every received broadcast object, which signalling information allows a consistent reassembly of said data fragments into an information category of said information service on basis of predefined protocol rules; and
performing a defragmentation within each of categories representing said information service to create said information service.

24. Method according to claim 23, characterized in that said defragmentation is performed dependent on the information content of the data to be transmitted.

25. A receiver to receive an information service in a broadcast transmission system, comprising:
means for receiving broadcast objects;
means for extracting signalling information and a data fragment of every received broadcast object, which signalling information allows a consistent reassembly of said data fragments into an information category of said information service on basis of predefined protocol rules; and
means for performing a defragmentation within each of categories representing said information service to create said information service.
